(19) United States
(12) Patent Application Publication
(10) Pub. No.: US 2016/0227953 A1
(43) Pub. Date: Aug. 11, 2016

(54) A CURTAIN SYSTEM

(71) Applicants: Christiene Elizabeth BAILEY, Durban (ZA); Richard William FOORD, Durban (ZA)

(72) Inventors: Christiene Elizabeth BAILEY, Durban (ZA); Richard William FOORD, Durban (ZA)

(21) Appl. No.: 15/023,508

(22) PCT Filed: Aug. 19, 2014
(86) PCT No.: PCT/ZA2014/000039

§ 371 Date: Mar. 21, 2016

(30) Foreign Application Priority Data
Sep. 23, 2013 (ZA) 2013/08785

(51) Int. Cl. A47H 13/14; B29C 65/08; A47H 23/00

(52) U.S. Cl. CPC A47H 13/14; A47H 23/00; B29C 65/08; B29L 2016/00

(57) ABSTRACT

A pleating device for use with a pleating tape attachable along an upper end region of a drapery panel, the pleating tape having elongate vertically-extending pockets defined at predetermined spaced apart locations, the pockets being open at upper and lower ends thereof, the pleating device including a least one pair of fingers being adapted to be inserted into said pockets so as to form at least one vertically-extending pleat; and a spacer body attachable to a drapery rail and to the pair of fingers, wherein the spacer body is locatable in the pleat and extends transversely from a longitudinal axis of the fingers to brace the pleat.

### TECHNICAL FIELD OF THE INVENTION

The invention is in the field of curtain systems for use on drapery panels.

### BACKGROUND TO THE INVENTION

Pleating devices in the form of pleating hooks for use with pleating tape, are generally well-known.

Various hooks are shaped to fit into pleating tape comprising flexible sheet material which is stitched onto an upper end region of a curtain and which defines elongate pockets having open lower ends along its length.

These hooks are received by the tape, and then mounted to a curtain rail. These hooks are not suitable for all applications and accordingly there have therefore been products made which could be used in forming oversized pleats whilst remaining secured to the tape.

The inventor believes that there is a need for a curtain system allowing for the efficient removal and installation of a curtain, whilst uniformly and stably bracing the pleats of a curtain, ensuring the curtain is adequately attached to the curtain rail and alleviating the abovementioned problems, at least partially.

### SUMMARY OF THE INVENTION

According to the invention, there is provided a pleating device for use with a pleating tape attachable along an upper end region of a drapery panel, the pleating tape having elongate vertically-extending pockets defined at predetermined spaced apart locations, the pockets being open at upper and lower ends thereof, the pleating device comprising:
at least one pair of fingers being adapted to be inserted into said pockets so as to form at least one vertically-extending pleat; and
a spacer body attachable to a drapery rail and to the pair of fingers, wherein the spacer body is locatable in the pleat and extends transversely from a longitudinal axis of the fingers to brace the pleat.

In this way, the structural integrity of the pleat is maintained, as the spacer braces or holds the form of the pleat along its length.

The fingers may have upper and lower ends having connecting formations disposed adjacent the ends for removable attachment to the spacer body.

The spacer body may be of a unitary construction and may comprise an elongate vertical section ending in a loop-like top portion and a transversely extending bottom portion, wherein the top and bottom portions comprise attachment means for attachment to the connecting formations of the fingers such that, in use the fingers shoulder each other in a substantially parallel fashion and are opposite, spaced apart from and substantially parallel to the elongate vertical section, wherein that the spacer body is disposed within a pleat such that the elongate vertical section braces a distal end of the pleat from within the same.

The spacer body may be roughly C-shaped.

The top portion may be substantially U-shaped. The drapery rail may be a pole-like drapery rail received axially through the top portion of the device, in use. The top portion and a portion of a vertical section may be of exposed, in use, and may therefore be constructed of an aesthetically pleasing material or may have an aesthetically pleasing finish.

The bottom portion may curve transversely from the vertical section to the attachment means.

In an alternative embodiment of the invention, the spacer body may comprise a U-shaped top portion, extending from the connecting formation attached to the upper end of the fingers. The U-shaped top portion may have an extension which is disposed within a pleat such that the extension braces the pleat. The extension may be removably attachable to the U-shaped portion, and the extension may include an engagement formation on an end thereof, to engage the U-shaped portion, and a hook on the free end, to hook relative to the pleating tape. The extension may be engaged relative to the U-shaped portion before or after the U-shaped portion has been inserted into the pleating tape. The connecting formation on the bottom end of the fingers is not connected to the spacer body in this embodiment, and merely connects to the fingers and hold them in place.

The engagement formation on the extension may be in the form of a tongue in groove formation, thereby attaching the extension to the U-shaped portion.

In an embodiment of the invention, the spacer body is constructed of a different material to/from the fingers.

The fingers may be configured to be inserted upwardly into the pockets of the tape. The attachment means of the top and bottom portions of the spacer body may be configured to attach to the fingers in a manner to maintain a predetermined spaced apart parallel relationship between the fingers.

In this embodiment of the invention, the lower ends of the fingers are fixedly attached to attachment means of the bottom portion of the spacer body, the fingers being held in a fixed spacial relationship.

The spacer body, particularly, the vertical section may comprise one or more barbs projecting outwardly therefrom to engage with the drapery panel in the pleat so as to further secure the pleat thereto.

According to a second aspect of the invention, there is provided a pleating system including the pleating device as hereinbefore described, and a strip of pleating tape securable to a drapery panel as hereinbefore described.

The pleating tape may be constructed of non-woven fabrics.

The pleating tape may be manufactured by welding a first panel-like blank ultrasonically to a second panel-like blank.

According to a third aspect of the invention, there is provided a method of manufacturing a pleating tape for attachment along an upper end region of a drapery panel, the method comprising:
feeding a first panel-like blank and a second panel-like blank to an ultrasonic welding means; an
welding the first blank to the second blank at regular intervals thereby to form elongate vertically-extending pockets defined at predetermined spaced locations along an upper end region thereof, the pockets being open at upper and lower ends thereof.

The first and second blanks may be strips of non-woven fabric. The first and second blanks may be constructed from a thermoplastics material. The first blank may be fed to the ultrasonic welding means on top of the second blank.

According to a fourth aspect of the invention, there is provided an apparatus for forming a pleating tape attachable along an upper end region of a drapery panel, the apparatus comprising:
an ultrasonic welding means;
a roller disposed operatively adjacent the ultrasonic welding means, the roller defining a plurality of protrusions thereon at predetermined spaced locations such that in use, first and second blanks fed to the apparatus are welded together at the protrusions thereby to form the pleating tape having elongate vertically-extending pockets defined at predetermined spaced locations, the pockets being open at upper and lower ends thereof.

The perforations correspond to the locations on the pleating tape which require welding.

### DESCRIPTION OF THE DRAWINGS

The invention will now be described with reference to the following non-limiting drawings:

FIG. 1 shows a perspective view of a first embodiment of a pleating device with the fingers in an unattached configuration;

FIG. 2 shows another perspective view of the first embodiment of the pleating device with the fingers in an unattached configuration;

FIG. 3 shows perspective view of the first embodiment of the pleating device with the fingers in an attached configuration;

FIG. 4 shows a perspective view of the first embodiment of the pleating device, in use and connected to pleating tape and forming a pleat in a drapery panel;

FIG. 5 shows a perspective view of a portion of a first blank and a second blank forming the pleating tape, as fed to an apparatus for forming a pleating tape;

FIG. 6 shows a portion of a formed pleating tape;

FIG. 7 shows a schematic illustration of an apparatus for forming a pleating tape;

FIG. 8 shows a perspective view of an apparatus for forming a pleating tape;

FIG. 9 shows a perspective side view of a second embodiment of the pleating device, and

FIG. 10 shows a further perspective side view of the second embodiment of the invention.

Reference numeral 10 refers to a pleating device in accordance with the invention.

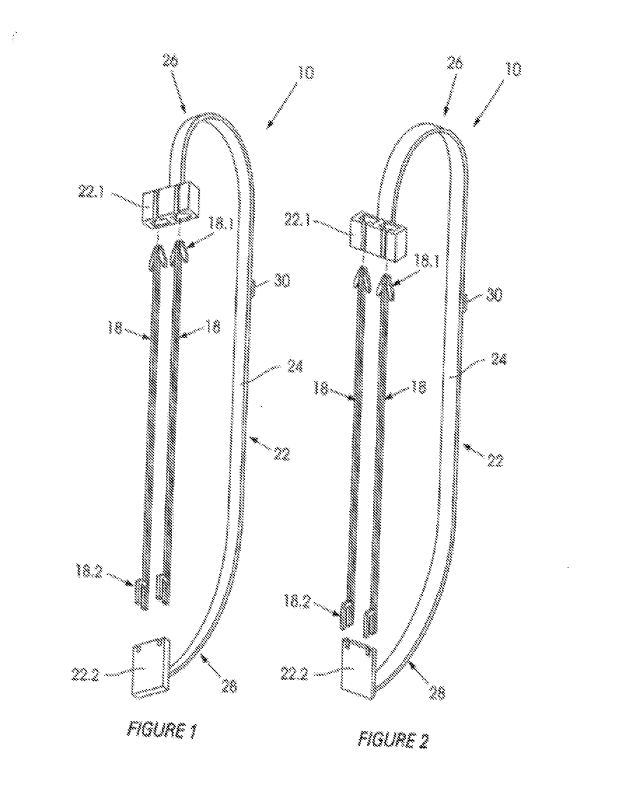

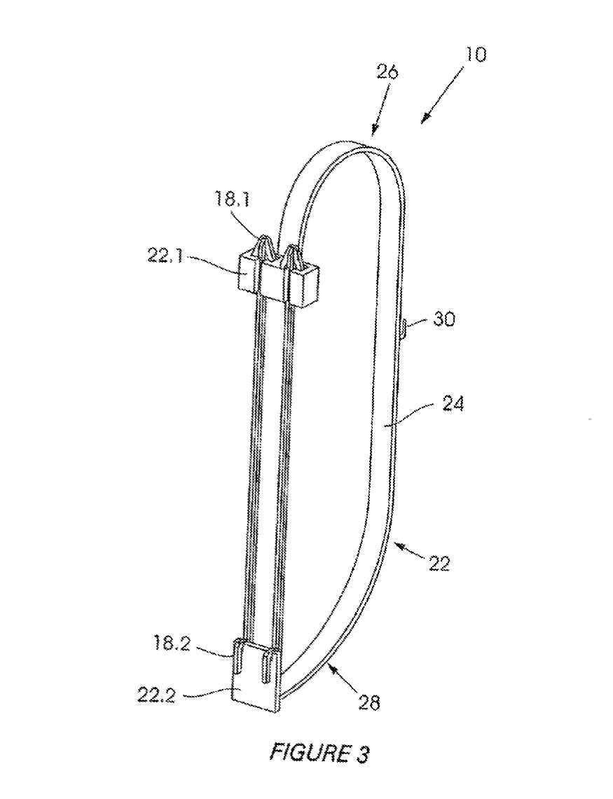

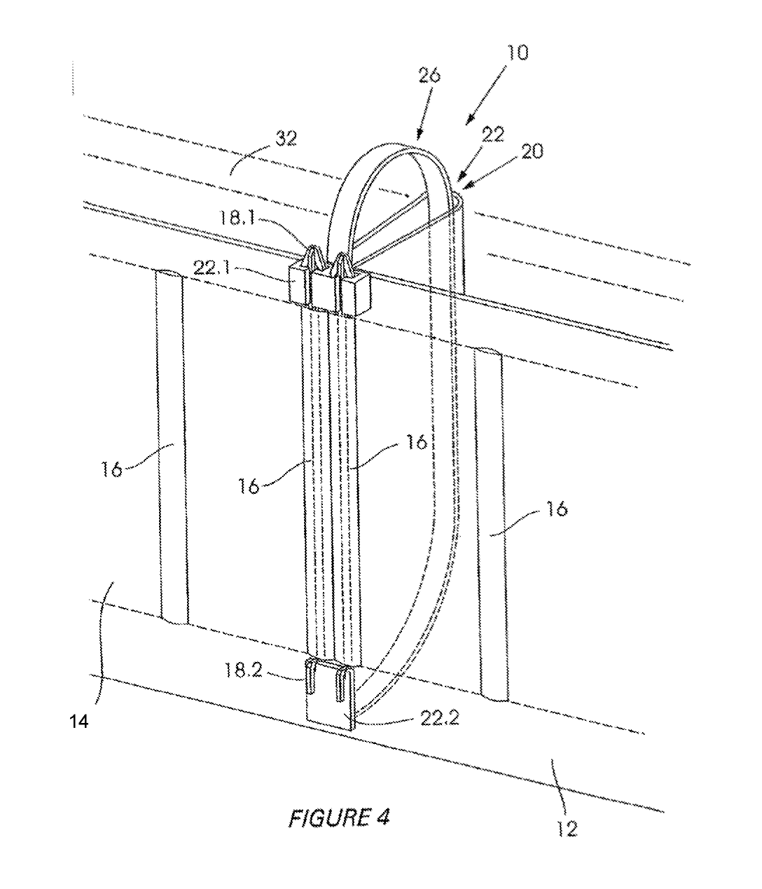

Referring to FIGS. 1 to 4 of the drawings, the pleating device 10 is configured for use with a drapery panel such as a curtain 12 illustrated in FIG. 4, having a strip of flexible pleating tape 14 secured to an upper end region of the curtain 12. The pleating tape 14 defines elongate vertically-extending pockets 16 having open upper and lower ends, the pockets 14 being defined at predetermined laterally spaced locations along the length of the pleating tape 14.

The pleating device 10 comprises a pair of fingers 18 of moulded plastics material adapted to be inserted into the pockets 14 so as to form a vertically-extending pleat 20. The fingers 18 are substantially similar elongate fingers 18 comprising non-matching connecting formations 18.1 and 18.2 provided at upper and lower ends thereof, respectively. The fingers 18 are approximately 170 mm in length.

The pleating device 10 also comprises a spacer body 22 attachable to the pair of fingers 18. The spacer body 22 extends, in use when the fingers 18 are in the pockets 14, transversely from a longitudinal axis of the fingers 18 to brace the pleat 20 from within, as illustrated in FIG. 4. The spacer body 22 is conveniently shaped and/or dimensioned to give the pleat 20 its desired shape, keeping it firmly in place and also ensuring even spacing or height of the pleat 20 from top to bottom.

In the first embodiment of the invention as shown in FIGS. 1 to 4, the spacer body 22 is of a unitary construction rid roughly C-shaped such that the fingers 18 are attachable to free ends thereof in assembly to form a closed loop. In particular, the body 22 comprises an elongate vertical section 24 extending to a U-shaped hook-like top portion 26, at an upper end thereof, an a transversely extending-curved bottom portion 28, at a bottom end thereof. The top and bottom portions 26, 28 comprise attachment means 22.1, 22.2, respectively at ends thereof, referred to as connecting devices, for attachment to the connecting formations 18.1, 18.2 of the pair of fingers 18. The fingers 18 are removably attachable to the spacer body 22.

In the first embodiment of the invention, the spacer body 22 and the fingers 18 flank each other in a substantially parallel fashion. In addition, the fingers 18 are located opposite, spaced from and substantially parallel to the elongate vertical section 24 which braces the pleat 20 from within the pleat 20. The bracing of the pleat 20 will allow for the desired width of the pleat 20.

In an embodiment of the invention, the section 24 comprises one or more outwardly projecting barbs 30 which assist in securing the pleating device 10 to the pleat 20.

The connecting formation 18.2 is in the form of a U-Shaped foot configured to engage with a substantially square planar holding means 22.2 having a notch to receive the U-shaped foot snugly therein. The connecting formation 18.1 on the other hand is in the form of an arrow-head like formation configured to be deformably receivable within the attachment means 22.1, in use. To this end, the attachment means 22.1 may be in the form of a collar having an internal structure to deform the connecting formation and retain the same removably therein, for example, in a snap-fit manner. In this way, the fingers 18 are attachable to the spacer body 22 in a relatively secure manner thereby maintaining the integrity of the pleat 20, when in use. In addition, it will be noted that the U-shaped for is seen to step radially outwardly from the longitudinal axis of the finger 18 thereby to further limit rotation of the finger 18 when in use. It will be noted that in other example embodiments, the connecting formation 18.1 may be a key-hole like attachment means so as not to be bulking in a pleat, in use.

The drapery rail as shown in FIG. 4 to which a curtain 12 is to be hung on may be a rod which is received axially through the top portion 26 thereby to hang the curtain 12 in a contemporary fashion. It follows that the top portion 26 of the device 10 is usually exposed in use as illustrated in FIG. 4. In some embodiments, the body 22 may be constructed of a wood, plastic or metallic material with an attractive or aesthetically pleasing finish. However, in some low cost example embodiments, not illustrated, the top portion 26 may be constructed of a more expensive attractive material and attached to the rest of the body 22 which is constructed of an inexpensive material such as plastic. Instead, or in addition, the top portion 26 may have an aesthetically pleasing treatment applied thereto.

When in use, as shown in FIGS. 1 to 4, the curtain is gathered so as to bring two selected pockets 16 together or adjacent each other such that the spacing of the pockets 16 corresponds with the spacing between the pair of fingers 18 in assembly or attachment to the spacer body 22 so as to form the pleat 20. The upper ends of the fingers 18 are then inserted into lower open ends of the pockets 16 so as to form one pleat 20 within the gathered portion of the curtain 12. Once the fingers 18 are fully inserted into the pockets, the upper ends of the fingers 19 project form the open upper ends of the pockets 16.

The spacer body 22 is then located in the formed pleat 20 and the attachment means 22.2 is engaged with the connecting formations 18.2. The fingers 18, which are substantially flexible to allow manipulation of the same are urged into register with the attachment means 22.1 and in particular the connecting formations 18.1 are urged into the attachment means 22.1 which receive and resiliently deform the formations 18.1 and retain the same therein essentially attaching, in a secure manner, the fingers 18 in the pockets 16 to the spacer body 22. In this way, the spacer body 22 gives the pleat 20 its form and keeps the same in place by projecting toward the distal end of the pleat 20 form within the same. To this end the barbs 30 aid in preventing the pleat from falling down the section 24.

It will be noted that the fingers 18 in the pockets 16 attached to the ends of the spacer body 18 essentially serves as a base or holding means for the body 22 to project into the pleat.

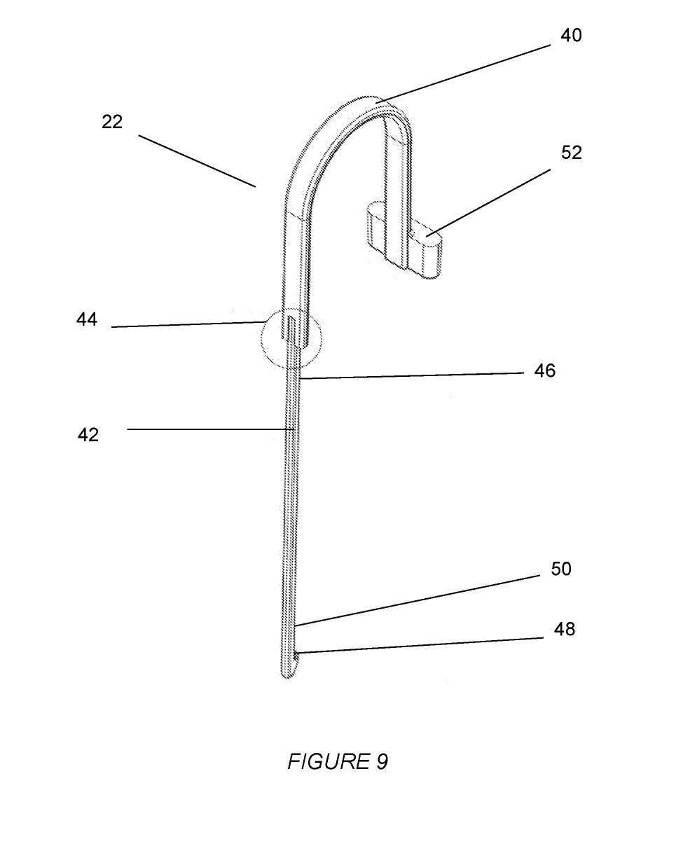

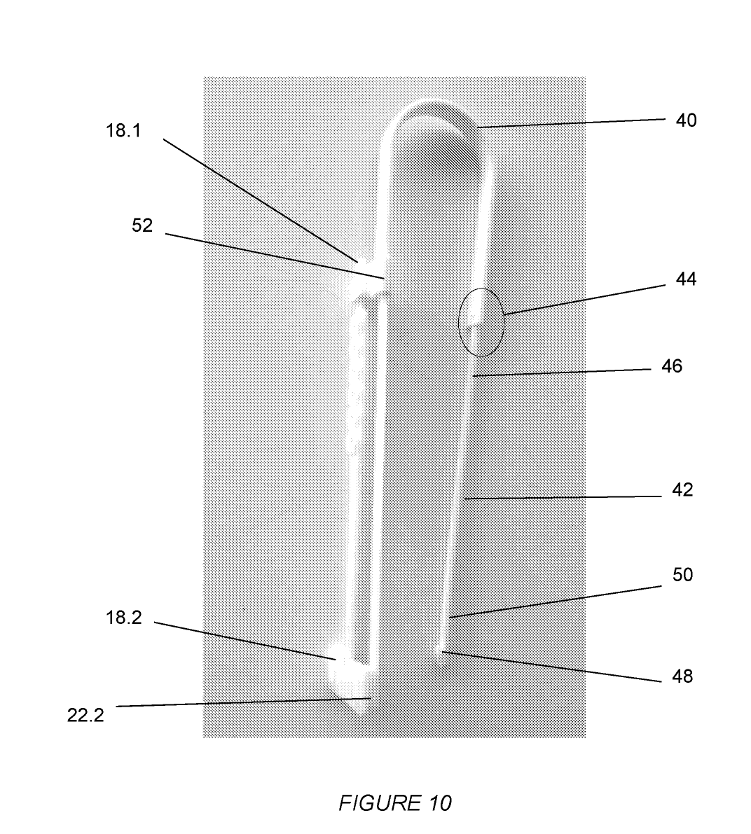

In a second embodiment of the invention as shown in FIG. 9, the spacer body 22 comprises a U-shaped top portion 40, extending from the connecting formation 52 attached to the upper end of the fingers 18. The U-shaped top portion 40 has an extension 42 which is disposed within a pleat such that the extension 42 braces the pleat. The extension 42 is removably attachable to the U-shaped portion 40, by a tongue in groove arrangement, and the extension 42 includes an engagement formation 44 on an end 46 thereof, to engage the U-shaped portion 40, and a hook 48 on the further end 50, to hook relative to the pleating tape. The extension 42 is engaged relative to the U-shaped portion 40 before or after the U-shaped portion 40 has been inserted into the pleating tape. The connecting formation on the bottom end of the fingers are not connected to the spacer body in this embodiment, and merely connect to the fingers and hold them in place.

A plurality of devices 10 may be attached in a similar manner and gathered together such that the top portions 26 or 40 thereof, are aligned for passage of the drapery rail 32 axially therethrough. The rail 32 with the curtain attached thereto via the devices 10 are then mounted in a desired location to mounting means to which the rail 32 is mountable, in a conventional fashion.

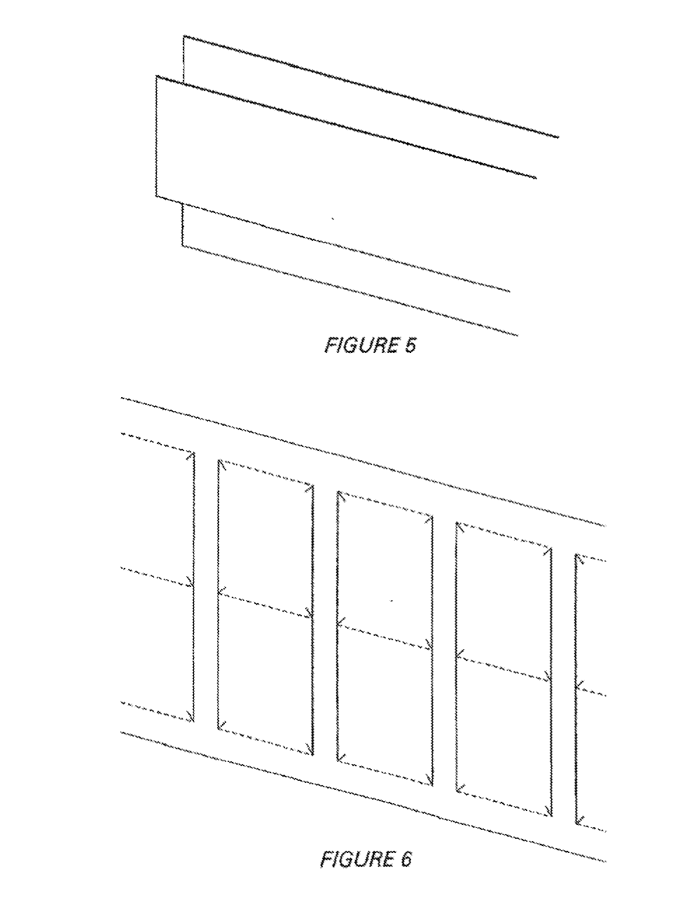

FIG. 5 shows that the pleating tape 14 comprises a first planar strip-like blank 14.1 and a second planar strip-like blank 14.2. The blanks 14.1 and 14.2 are selected from a non-woven material such as thermoplastics material having at least 60% synthetic plastics material. The first blank 14.1 or in other words the front blank lies on top of the second blank 14.2 or in other words the backing blank in forming the pleating tape 14. The first blank 14.1 has a width of approximately 150 mm whereas the second blank 14.2 has a width of approximately 200 mm.

The front and backing blanks 14.1 and 14.2 may be ultrasonically welded to form the pleating tape 14 as illustrated more clearly in FIG. 5.

The tape 14 is ultrasonically welded pleating tape 14 has welds 50 so as to define the elongate vertically extending pockets 52 having open ends 56. The pockets 52 have a length of 170 mm. In addition, support welds 54 provide additional support and structural integrity of the tape 14. It will be appreciated that the combined use of the pleating tape 12 and the device 10 is what prevents the curtain pleats from flopping untidily when the curtain if attached to the hanging rail. The pleats formed using this tape with its pockets evenly spaced are uniform and evenly spaced therefore the pleating tape becomes as integral part of the invention.

It will be noted that all the conventional pleating tapes are constructed by means of a weaving machine and then put through a starching process. This conventional process is not suitable for constructing straights, evenly spaced pockets especially when manufacturing pleating tapers 200 mm in width.

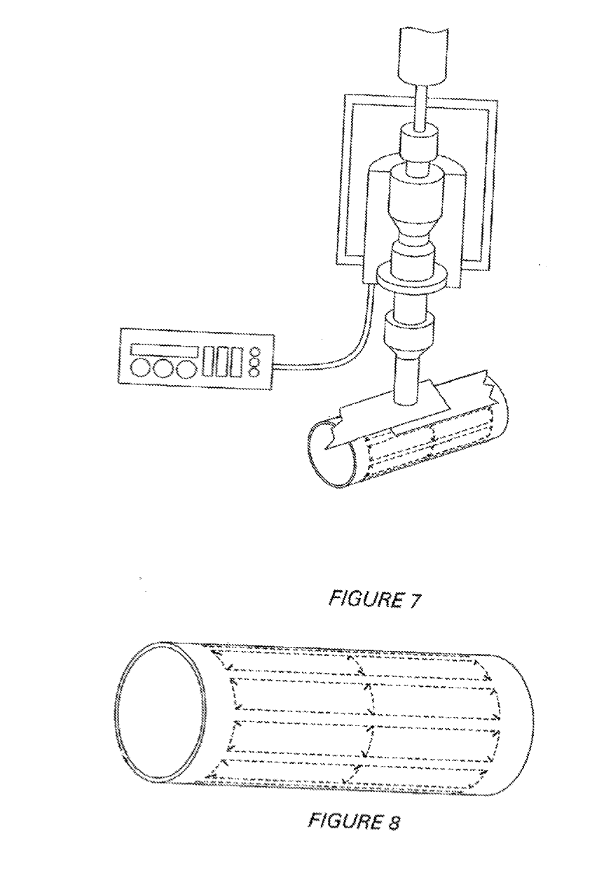

In this regard, reference is now made to FIG. 7 of the drawings where an apparatus for forming the pleating tape 14 in accordance with an example embodiment of the invention is generally indicated with reference numeral 70.

The apparatus 70 may comprise an essentially conventional ultrasonic welder to weld the first blank 14.1 to the second blank 14.2 to form the pleating tape 14 as described. The welder 72 is typically controlled by a suitable control system, for example, a computer controlled system 76.

The apparatus 70 also comprises a cylindrical anvil or roller 74, as also shown in FIG. 8, operatively disposed adjacent the welder 72, below a sonotrode or horn thereof. In a preferred example embodiment (not shown) the horn is of the same length as the longitudinal length of the roller 74. The roller 74 is configured to rotate as the blanks 14.1 and 14.2 are fed (optionally by rolling action of the roller 74) to the sonotrode or horn of the welder 72 in rolling fashion such that the horn and the roller 74 sandwich the blanks 14.1 and 14.2. The sonotrode or horn operatively welds the blanks 14.1, 14.2 together onto the roller 74 acting as an anvil.

To this end the roller 74 comprises a plurality of protrusions 76 arranged in a regular fashion on the body of the roller 74. These protrusions 76 serve as points of contact during welding such that the blanks 14.1 and 14.2 are welded at the protrusions 76. The protrusions 76 may project radially outwardly from the roller by about 2 mm. It will be appreciated that it is at the points of contact that the material of the blanks 14.2 and 14.2 melts, bonds and solidifies during ultrasonic welding to form the tape 14. It follows that zones with no protrusions 76, for example, zones 78 result in no welds in the tape 14. In this regard, it will be noted that the zones 78 form the pockets 52 as the blanks 14.1 and 14.2 are welded together. The roller 74 may be constructed of steel.

Though not illustrated, it will be appreciated that the blanks 14.1 and 14.2 to be welded are secured in a fixture which holds the say in place and square to the horn when welding takes place.

The tape 14 is advantageously made of a thermoplastics material which is stable before processing and after therefore the tape 14 does not distort, etc. There is also no need for heat setting, straightening and stiffening as is the case with conventional knitted or weaved tapes.

Also, not illustrated, the apparatus 70 comprises take up rollers, feeding systems, etc.

In use, the first blank 14.1 and the second blank 14.2 are provided in rolls. The first blank 14.1 on top of the second blank 14.2 is simultaneously fed into the apparatus 70 entering between the roller 74 and a fixture or foot plate (not illustrated). As the blanks 14.1 and 14.2 move through the apparatus 70, controlled pressure is constantly applied and the horn of the apparatus 70 vibrates vertically approximately 20 000 to 40 000 times per second for a predetermined period of time called weld time.

The vibratory action of the horn is directed to limited points of contact between the two parts of the thermoplastics material, creating heat which bonds the blanks 14.1 and 14.2 at the protrusions 76. The clamping force between the horn and the roller 74 allows the melting parts to fuse, cool and solidify. This is known as hold time. In this way, approximately four meters of tape may be manufactures per minute.

The take up rollers (not illustrated) then roll the welded tape 14 into rolls.

In another example embodiment not shown, other heat welding e.g. laser welding may be used to form the tape 14.

These figures show a novel pleating device in accordance with the invention.

1-23. (canceled)

24. A pleating device for use with a pleating tape attachable along an upper end region of a drapery panel, the pleating tape having elongate vertically extending pockets defined at predetermined spaced apart locations, the pockets being open at upper and lower ends thereof, the pleating device comprising:
at least one pair of fingers being adapted to be inserted into said pockets so as to form at least one vertically-extending pleat; and
a spacer body attachable to a drapery rail and to the pair of fingers, wherein the spacer body is locatable in the pleat and extends transversely from a longitudinal axis of the fingers to brace the pleat.

25. The pleating device as claimed in claim 24, wherein fingers have upper and lower ends having connecting formations disposed adjacent the ends for removable attachment to the spacer body.

26. The pleating device as claimed in claim 25, wherein the spacer body is of a unitary construction and comprises an elongate vertical section ending to a loop-like top portion, and a transversely extending bottom portion.

27. The pleating device as claimed in claim 26, wherein the top and bottom portions comprise attachment means for attachment to the connecting formations of the fingers such that the fingers shoulder each other in a substantially parallel fashion and are opposite, spaced from and substantially parallel to the elongate vertical section.

28. The pleating device as claimed in claim 26, wherein the spacer body is disposed within a pleat such that the elongate vertical section braces a distal end the pleat.

29. The pleating device as claimed in claim 26, wherein the spacer body is C-shaped.

30. The pleating device as claimed in claim 26, wherein a top portion of the spacer body is substantially U-shaped to axially receive a drapery rail.

31. The pleating device as claimed in claim 26, wherein the bottom portion curves transversely from the vertical section to the attachment means.

32. The pleating device as claimed in claim 24, wherein in a further embodiment of the invention, the spacer body comprises a U-shaped top portion, extending from the connecting formation attached to the upper end of the fingers.

33. The pleating device as claimed in claim 32, wherein the U-shaped top portion has an extension which is disposed within a pleat such that the extension braces the pleat.

34. The pleating device as claimed in claim 32, wherein the extension is removably attachable to the U-shaped portion, and the extension includes an engagement formation on an end thereof, to engage the U-shaped portion, and a hook on the free end, to hook relative to the pleating tape.

35. The pleating device as claimed in claim 34, wherein the engagement formation is in the form of a tongue and groove arrangement and the extension is engaged relative to the U-shaped portion before or after the U-shaped portion has been inserted into the pleating tape.

36. The pleating device as claimed in claim 32, wherein the connecting formation only connects to the fingers and holds them in place.

37. The pleating device as claimed in claim 24, wherein the spacer body is constructed of a different material than the fingers.

38. The pleating device as claimed in claim 24, wherein the fingers are configured to be inserted upwardly into the said pockets.

39. The pleating device as claimed in claim 24, wherein the attachment means of the top and bottom portions of the spacer body are configured to attach to the fingers in a manner to maintain a predetermined spaced parallel relationship between the fingers.

40. The pleating device as claimed in claim 24, wherein the vertical section of the spacer body comprises one or more barbs projecting outwardly therefrom to engage with the drapery panel in the pleat so as to further secure the pleat thereto.

41. A method of manufacturing a pleating tape for attachment along an upper end region of a drapery panel, the method comprising:
feeding a first panel-like blank and a second panel-like blank to an ultrasonic welding means; and
welding the first blank to the second blank at regular intervals thereby to form elongate vertically-extending pockets defined at predetermined spaced locations along an upper end region thereof, the pockets being open at upper and lower ends thereof.

42. A method of manufacturing as claimed in claim 41, wherein the first and second blanks are strips of non-woven fabric and constructed from a thermoplastics material and fed into the ultrasonic welding means on top of the second blank.

43. An apparatus for forming a pleating tape attachable along an upper end region of a drapery panel, the apparatus comprising:
an ultrasonic welding means; and
a roller disposed operatively adjacent the ultrasonic welding means, the roller defining a plurality of protrusions thereon at predetermined spaced locations such that in use, first and second blanks fed to the apparatus are welded together at the protrusions thereby to firm the pleating tape having elongate vertically-extending pockets defined at predetermined spaced locations, the pockets being open at upper and lower ends thereof.

44. An apparatus as claimed in claim 43, wherein the perforations correspond to the locations on the pleating tape which require welding.
